(19) United States
(12) Patent Application Publication
(10) Pub. No.: US 2026/0063469 A1
(43) Pub. Date: Mar. 5, 2026

(54) PHOTONIC INTEGRATED CIRCUIT CHIP FOR DISTRIBUTED ACOUSTIC SENSING

(71) Applicant: Xiaotian Steve Yao, Las Vegas, NV (US)

(72) Inventor: Xiaotian Steve Yao, Las Vegas, NV (US)

(21) Appl. No.: 19/319,424

(22) Filed: Sep. 4, 2025

Related U.S. Application Data
(60) Provisional application No. 63/690,647, filed on Sep. 4, 2024.

(51) Int. Cl. G01H 9/00

(52) U.S. Cl. CPC G01H 9/004

(57) ABSTRACT

The disclosure of this patent document provides a photonic integrated circuit (PIC) chip for integrating various component of the distributed acoustic sensing (DAS) interrogator on the same chip to enable low cost, extremely small size and weight, and low power consumption for the adoption of various applications.

### CROSS-REFERENCE TO RELATED APPLICATION(S)

This application claims priority to and benefits of U.S. Provisional Patent Application No. 63/690,647 entitled “PHOTONIC INTEGRATED CIRCUIT CHIP FOR DISTRIBUTED ACOUSTIC SENSING” and filed on Sep. 4, 2024 by Xiaotian Steve Yao.

### TECHNICAL FIELD

The disclosure of this patent document relates to optical sensing devices for distributed acoustic sensing (DAS) via a sensing fiber.

### BACKGROUND

Distributed acoustic sensing (DAS) can be used in a wide range of applications, including seismic wave detection, oil exploration, earthquake research, intrusion detection [1], oil pipeline protection, geophysics observation [2], infrastructure integrity monitoring [3], structural fault location, and vehicle tracking [4], etc.

### SUMMARY

The disclosure of this patent document provides a photonic integrated circuit (PIC) chip for integrating various component of the DAS interrogator on the same chip to enable low cost, extremely small size and weight, and low power consumption for the adoption of a wide range applications.

In one implementation, the disclosed technology can be used to provide an optical sensing device for distributed acoustic sensing using a sensing fiber. This optical sensing device includes a substrate; a laser supported by the substrate to produce laser light; an optical modulator supported by the substrate and located to receive the laser light from the laser to produce laser pulses for sensing local phase disturbances at various locations along the sensing fiber by detecting backscattering light of the laser pulses at the various locations along the fiber; a polarization device supported by the substrate to receive the backscattered light from the sensing fiber and to split the received backscattered light from the sensing fiber into first optical beam in a first polarization and a second optical beam in a second polarization that is orthogonal to the first polarization and to rotate the second polarization of the second optical beam by 90 degrees to produce a second polarization beam in the first polarization; a first optical coupler to split the first optical beam into two branches, with one of the branches having a longer path than the other branch; a second optical coupler to split the second optical beam into two branches, with one of the branches having a longer path than the other branch; a first optical coherent receiver supported by the substrate to receive the two beams from the first optical coupler derived from the first optical beam in the first optical polarization to produce three or more first optical coherent receiver output signals that carry information of local phase disturbances at various locations along the sensing fiber; and a second optical coherent receiver supported by the substrate to receive the two beams from the second optical coupler derived from the second optical beam in the first optical polarization to produce two or more second optical coherent receiver output signals that carry information of local phase disturbances at various locations along the sensing fiber.

In another implementation, the disclosed technology can be used to provide an optical sensing device for distributed acoustic sensing using a sensing fiber. This optical sensing device includes a substrate; a laser supported by the substrate to produce laser light; an optical modulator supported by the substrate and located to receive the laser light from the laser to produce laser pulses for sensing local phase disturbances at various locations along the sensing fiber by detecting backscattering light of the laser pulses reflected at the various locations along the fiber; a 2-state polarization generator (PSG) or a polarization controller with an output polarizer coupled to receive the backscattered light from the sensing fiber and to control optical polarization of the received backscattered light from the sensing fiber; an optical coupler to split light from the 2-state polarization generator (PSG) or the polarization controller into first optical beam and a second optical beam in a common polarization traveling in waveguides of different lengths; an optical coherent receiver supported by the substrate to receive the first optical and the second optical beam to produce different optical coherent receiver output signals that carry information of local phase disturbances at various locations along the sensing fiber.

In another implementation, the disclosed technology can be used to provide an optical sensing device for distributed acoustic sensing using a sensing fiber. This device includes a substrate; a laser supported by the substrate to produce laser light; an optical modulator supported by the substrate and located to receive the laser light from the laser to produce laser pulses for sensing local phase disturbances at various locations along the sensing fiber by detecting backscattering light of the laser pulses reflected at the various locations along the sensing fiber; a polarization device outside the substrate to receive the backscattered light from the sensing fiber and to split the received backscattered light from the sensing fiber into first optical beam in a first polarization and a second optical beam in a second polarization that is orthogonal to the first polarization; a first optical coupler to receive the first optical beam in the first polarization and to split the first optical beam into 2 first optical beams in the first polarization; a second optical coupler to receive the second optical beam in the second polarization and to split the second optical beam into 2 second optical beams in the second polarization; a first optical coherent receiver supported by the substrate to receive the 2 first optical beams in the first optical polarization to produce two or more first optical coherent receiver output signals that carry information of local phase disturbances at various locations along the sensing fiber; and a second optical coherent receiver supported by the substrate to receive the 2 second optical beams in the first optical polarization to produce two or more second optical coherent receiver output signals that carry information of local phase disturbances at various locations along the sensing fiber.

In another implementation, the disclosed technology can be used to provide an optical sensing device for distributed acoustic sensing using a sensing fiber, which includes a substrate; a laser supported by the substrate to produce laser light; an optical modulator supported by the substrate and located to receive the laser light from the laser to produce laser pulses for sensing local phase disturbances at various locations along the sensing fiber by detecting backscattering light of the laser pulses reflected at the various locations along the sensing fiber; and a polarization device supported by the substrate to receive the backscattered light from the sensing fiber and to split the received backscattered light from the sensing fiber into first optical beam in a first polarization and a second optical beam in a second polarization that is orthogonal to the first polarization and to rotate the second polarization of the second optical beam by 90 degrees to produce a second polarization beam in the first polarization. This device further includes a first optical coherent receiver supported by the substrate to receive (1) the first optical beam in the first optical polarization and (2) a first portion of the laser light from the laser as a first local optical oscillator signal for optical coherent detection to produce two or more first optical coherent receiver output signals that carry information of local phase disturbances at various locations along the sensing fiber; and a second optical coherent receiver supported by the substrate to receive (1) the second optical beam in the second optical polarization and (2) a second portion of the laser light from the laser as a second local optical oscillator signal for optical coherent detection to produce two or more second optical coherent receiver output signals that carry information of local phase disturbances at various locations along the sensing fiber.

In yet another implementation, the disclosed technology can be used to provide an optical sensing device for distributed acoustic sensing using a sensing fiber, which includes a substrate; a laser supported by the substrate to produce laser light; an optical modulator supported by the substrate and located to receive the laser light from the laser to produce laser pulses for sensing local phase disturbances at various locations along the sensing fiber by detecting backscattering light of the laser pulses reflected at the various locations along the sensing fiber; a polarization controller supported by the substrate and coupled to receive the backscattered light from the sensing fiber and to control optical polarization of the received backscattered light from the sensing fiber; a polarizer supported by the substrate to select a portion of output light from the polarization controller as a polarized output light; and an optical coherent receiver supported by the substrate to receive (1) the polarized light and (2) a portion of the laser light from the laser as a local optical oscillator signal for optical coherent detection to produce different optical coherent receiver output signals that carry information of local phase disturbances at various locations along the sensing fiber.

The above and other implementations for optical sensing devices for distributed acoustic sensing are described in greater detail in the examples below.

### BRIEF DESCRIPTION OF THE DRAWINGS

FIG. 1 shows an example for implementing a first embodiment of a disclosed distributed acoustic sensing (DAS) interrogator chip. This specific DAS interrogator chip includes a substrate on which various components of the DAS interrogator are formed, including a laser such as distributed feedback (DFB) laser or a DFB laser chip, an add-drop microring resonator (MRR) for the self-injection locking of the DFB laser, a loop reflector or mirror for enhancing the self-injection locking, an optical modulator/switch for generating optical pulses, a semiconductor optical amplifier (SOA) for amplifying the optical pulses and enhancing the extinction ratio (ER) of the optical pulses, an optional bandpass filter (BPF) for filtering out the spontaneous emission noise from the SOA, a spot size converter (SSC) as an on-chip element for matching the mode field diameter of the output light by the chip with that of the output fiber pigtail for the optical chip output light to be carried by the sensing fiber, a second on-chip SSC for matching the mode field diameter of the input fiber pigtail for receiving returned light from the sensing fiber, a waveguide supporting both the TE and TM polarizations, a polarization splitting rotator (PSR) to split the orthogonal polarization component from the sensing fiber into separate paths and rotating the TM 90 degrees to TE mode, two 1×2 optical couplers each to split the light in each path into two optical arms, a delay line in one of the two optical arms, and two optical coherent receivers each to receive the light from the two optical arms. The optical modulator/switch is used to generate optical pulses with high extinction ratio using electric pulses generated by the electronic circuit and the SOA is used to amplify the optical signal in sync with the optical modulator/switch. The optical modulator/switch can be removed and only SOA is used to accomplish the switching function by driving it with pulsed electrical signal. An off-chip optical circulator is provided to route light between the chip and the sensing fiber.

FIG. 2 shows examples of three different configurations of the optical modulator/switch that can be used in the DAS interrogator chip in FIG. 1. a) An optical Mach-Zehnder modulator (MZM); b) A high extinction ratio (ER) modulator with a Mach-Zehnder interferometer (MZI) to adjust the powers into the two optical arms of a downstream Mach-Zehnder modulator (MZM) to ensure the powers at the output are equal; c) a modulator made with multiple microrings for achieving high ER.

FIG. 3 shows examples of three different configurations of the coherent receivers. a) 90° hybrid; b) 4×4 MMI where 2 input ports are used; c) 3×3 MMI where 2 input ports are used.

FIG. 4 shows an example for implementing a second embodiment of the disclosed DAS interrogator. This specific DAS interrogator chip includes a substrate on which various components of the DAS interrogator are formed, including, a laser such as an injection locked DFB laser, an optical pulse generator (modulator and SOA), an optional bandpass filter (BPF), three spot size converters (SSC) for matching the mode field diameter with that of the fiber pigtails, and a coherent receiver to receive light from the two arms. The modulator/switch is used to generate optical pulses with high extinction ratio using electric pulses generated by the electronic circuit and the SOA is used to amplify the optical signal in sync with the modulator/switch. The modulator/switch can be removed and only SOA is used to accomplish the switching function by driving it with pulsed electrical signal. Outside the DAS interrogator chip, a circulator is provided for routing the light from the DAS interrogator chip into the sensing fiber and vice versa; in addition, a 2-state polarization generator (PSG) or a polarization controller with an output polarizer is coupled between the chip and the optical circulator to process the returned light from the sensing fiber, a PM coupler is provided to split the returned light into two arms off the chip, a delay fiber (e.g., around 1-20 meters) is placed in one of the arms. The pigtails of the PM coupler, including the delay fiber, are all of PM fiber.

FIG. 5 shows an example for implementing a third embodiment of the disclosed DAS interrogator similar to that of FIG. 4, except the polarization controller is placed on the chip, followed by a TE pass polarizer and a 1×2 coupler to split the light into two arms, an optical delay is placed in one of the arms, and a coherent receiver to receive light from the two arms. The PSG or polarization controller can be constructed by a heater on the waveguide which has high birefringence.

FIG. 6 shows an example for implementing a fourth embodiment of the disclosed DAS interrogator similar to that of FIG. 4, except two coherent receivers are used for polarization diversity. In particular, a polarization beam splitter (PBS) is used to split two orthogonal polarizations into two paths, each path is further split into two arms, with one of the arms delayed by an extra length of fiber, before both arms enter their corresponding coherent receiver to extract vibration information in the sensing fiber. Note that the two output fibers from the PBS are of PM fiber. C1 and C2 are PM fiber couplers and their pigtails, including the delay fiber, are also of PM fiber.

FIG. 7 shows an example for implementing a fifth embodiment of the disclosed DAS interrogator to obtaining the sensing signal from the fiber by beating the backscattered/reflected signals with the laser light directly from the on-chip laser. Laser light from output 1 is first converted into optical pulse by the modulator/switch and the SOA before output to the sensing fiber. The backscattered and reflected light from the sensing fiber is separated by an optical circulator from the output light before entering the input waveguide with an SSC via a short length of single mode (SM) fiber, which then propagates in a waveguide supporting both TE and TM modes before being split by a PSR with the TE mode going to a first port and the TM mode going to the second port after being rotated 90 degrees to become a TE mode. On the other hand, the light from the laser source is split into two fibers before mixing with the lights from the two ports of the PSR in two coherent receivers, respectively, to producing two sets of mixed signals containing the local phase information, which can be extracted with further data processing to get local vibration information along the fiber.

FIG. 8 shows an example for implementing a sixth embodiment of the disclosed DAS interrogator for obtaining the sensing signal from the fiber by beating the backscattered/reflected signals with the laser light directly from the on-chip laser, like that of FIG. 7, but only uses a single coherent receiver. Laser light from output 1 is first converted into optical pulse by the modulator/switch and the SOA before output to the sensing fiber. The backscattered and reflected light from the sensing fiber is separated by an optical circulator from the output light before entering the input waveguide with an SSC via a short length of single mode (SM) fiber, which then propagates in a waveguide supporting both TE and TM modes. The state of polarization (SOP) of the light is then controlled by a polarization controller or rotator, followed by the polarizer before entering the coherent receiver through another piece of waveguide to mix with the light directly from the injection locked DFB laser to produce an interference signal containing the local phase information, which can be extracted with further data processing to get local vibration information along the fiber.

### DETAILED DESCRIPTION

A distributed acoustic sensing (DAS) system can be achieved by an optical sensing system based on a phase sensitive optical time domain reflectometer (OTDR) to detect local phase disturbances at various locations along a sensing fiber caused by an acoustic wave or a vibration, with the distance information determined by the time-of-flight of the optical pulse backscattered by the Rayleigh backscattering (RBS) inside the sensing fiber. The DAS system can be configured to include a sensing fiber, an interrogator, and a data processing unit, and has traditionally relied on using discrete optical components to construct the interrogator, which is bulky, expensive and power hungry, limiting its widespread adoption, especially for potable and aerospace applications where size, weight, and power consumption are critical, as well as for the Internet of Things (IoT), consumer electronics, and many other industrial applications where cost and size are major considerations.

An optical fiber used for the optical sensing and fiber optical monitor network systems may be subject to or suffer fiber vibration or acoustic or strain signals. For example, International Telecommunication Union recommended ITU-T G.652 or G.657 single-mode optical fiber and cables may be used in fiber sensing applications. Such vibration, acoustic or strain signals in a fiber sensing system may be measured by a coherent optical time domain reflectometer (C-OTDR), e.g., at 1550 nm or any wavelength within telecom bands from 1250 nm to 1650 nm, to distinguish an acoustic or vibration or strain signals from outside intrusions, such as personal voice, running or walking, or vehicle running, or machine digging, etc., by use of the measured fiber optical phase or length difference information between at least two different fiber distances or locations at one given wavelength.

Advantageously such measurement procedures can be extended to using a seismic vibration source for oil and gas exploration and other applications based on an interferometric method in which a vibration or an acoustic or a strain signal can induce a variation in the optical phase or length in a sensing fiber, such as a frequently installed telecom optical fiber. Although a traditional OTDR method could distinguish a fiber loss and length, however, various implementations of such method usually could not provide acoustic or vibration or strain characteristics on the sensing fiber because the traditional OTDR devices tend to have insufficient optical coherence that is needed to measure the optical phase or delay and cannot measure a high frequency for acoustic or vibration signals, such as from 10 Hz to several kHz, e.g. >100 KHz.

In order to properly characterize the acoustic or vibration or strain signal on the sensing fiber (S-FUT) it is important to estimate the fiber local optical phase or length prosperities, e.g. signal amplitude, frequency, etc., for a communications sensing optical fiber cable, e.g. using G.652 or G.657 or any single mode fiber (SMF) or even multi-mode fiber (MMF), so that it could be possible to accurately estimate any acoustic or vibration or strain signals along or close sensing fiber, however, currently OTDR measurement technique could not only provide such measurements, etc.

Thus, there is a need for a new method for characterizing such acoustic—or vibration—or strain-related fiber characteristics as a function of distance along a sensing fiber cable (S-FUT), for example, from a single-end of the sensing fiber, that can be used for the field monitoring, test and measurement for the optical sensing networks, for example, along oil or gas pipeline, well, etc. One potential test method to measure fiber acoustic or vibration or strain is to measure an acoustic or vibration or strain induced fiber length or optical phase or optical length delay changing or vibration, where the fiber length or optical phase can be induced by the fiber vibration or movement or strain or pressure and is proportional to acoustic or vibration or strain intensity as well following acoustic or vibration or strain signal frequency, so that it is possible to know both amplitude and frequency of the signal under testing properties, where previous reported methods may only determine relevant signal intensity for example in sine function that could not provide accurately signal amplitude and frequency as well previous reported methods may limit the laser coherence that may degrade the interference signal so as to have a poor optical signal to noise ratio. Some technical details on the optical distributed acoustic sensing (DAS) are described in U.S. Pat. No. 11,169,019B2 entitled “Distributed fiber optic acoustic sensor” by inventors Hongxin Chen and Xiaotian Steve Yao, which is incorporated by reference in its entirety as part of the disclosure of this patent document.

In addition, various features of the disclosed technology in this patent document are disclosed in U.S. Pat. No. 11,619,783B2 entitled “Sine-cosine optical frequency detection devices for photonics integrated circuits and applications in LiDAR and other distributed optical sensing” by inventor Xiaotian Steve Ya, which is incorporated by reference in its entirety as part of the disclosure of this patent document.

The disclosed technology in this patent document can be implemented in ways that meet a need for characterizing such high spatial resolved acoustic—or vibration—or strain-dependent characteristics as a function of distance along a sensing fiber cable from a single-end of the sensing fiber that could also distinguish event type based on the measured or monitored signals' amplitude and/or frequency, etc.

The technology for DAS in this patent document is designed in an integrated package on a chip to address various issues associated with using discrete optical components for constructing the DAS system. Specifically, the technology in this patent document provides a photonic integrated circuit (PIC) chip for integrating various component of the DAS interrogator on the same chip to enable low cost, extremely small size and weight, and low power consumption for the adoption of a wide range applications.

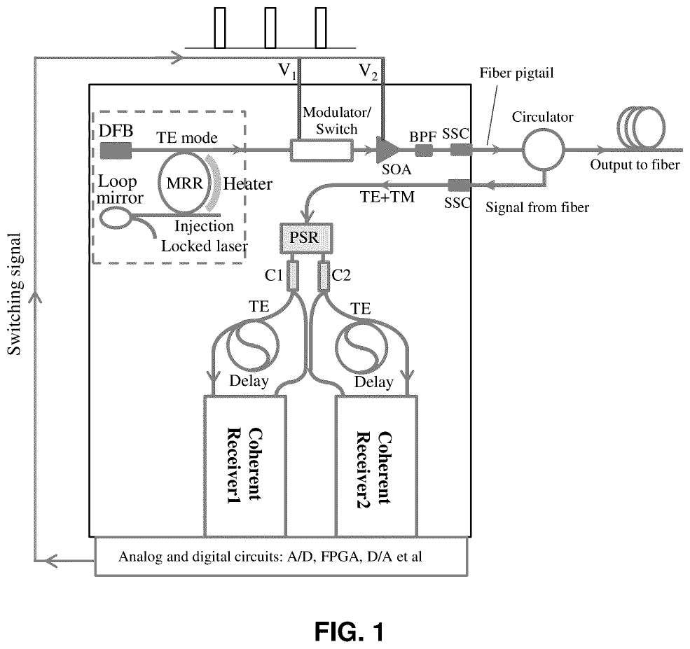

FIG. 1 illustrates an example of a first embodiment of the disclosed DAS PIC chip designed with polarization insensitivity. This DAS PIC chip example includes a substrate on which different components are formed or supported. For example, a laser such as a districted feedback (DFB) laser chip or module can be formed on or supported by the substrate to produce laser light at a desired laser wavelength. An add-drop micro-ring resonator (MRR) is formed on the substrate and is optically coupled to the DFB laser to receive a portion of the laser light from the DFB laser and to inject a portion of the light circulating in the MRR back into the DFB laser to achieve self-injection locking of the DFB laser so that the self-injection locked DFB laser can operate to produce laser light with an extremely narrow linewidth. A loop reflector or mirror is formed on or supported by the substrate and is optically coupled to the MRR so a portion of the light circulating in the MRR is coupled to the loop reflector or mirror and the reflected light from the loop reflector or mirror is coupled back into the MRR for enhancing the self-injection locking, of the DFB laser by the MRR. The MRR may be a tunable MRR with a mechanism to adjust its total effective optical length by changing cither its physical dimension or an optical index of refraction of at least a portion of the MRR. For example, an on-substrate heater may be provided to change the temperature of the MRR for implementing this tuning mechanism. An optical modulator modulator/switch is formed on or supported by the substrate to receive the output laser light from the injection locked DFB laser in response to a modulation control signal applied to the optical modulator modulator/switch so the modulated output light from the optical modulator modulator/switch becomes a series of optical pulses. As illustrated, the modulation control signal applied to the optical modulator modulator/switch is a signal of electronic pulses from a control electronic circuitry for controlling or operating the DAS PIC chip in FIG. 1. At the output of the optical modulator modulator/switch, a semiconductor optical amplifier (SOA) is formed on or supported by the substrate to receive the modulated light and to amplify the modulated light with optical pulses and to enhance the extinction ratio (ER) of the optical pulses in sync with the modulator/switch. In addition, an optional optical bandpass filter (BPF) is formed on o supported by the substrate to receive the amplified modulated light to filter out certain noise such as the spontaneous emission noise from the semiconductor optical amplifier (SOA). The light on the DAS PC chip is guided by optical waveguide formed on the substrate. An output optical coupler is also formed on or supported by the substrate as an optical output port for the DAS PC chip for interfacing with an optical fiber or fiber pigtail for coupling the light out of the DAS PC chip. This optical coupler may include, in the specific example shown in FIG. 1, a spot size converter (SSC) for matching the mode field diameter of the amplified modulated light on the chip with that of the output fiber pigtail. The optical fiber or fiber pigtail for coupling the light out of the DAS PC chip can be directed to a sensing fiber where returned light from the sensing fiber can be guided back to an optical splitter or an optical circulator in the sensing fiber or the fiber pigtail coupled to the DAS PC chip to be separated as an input optical signal.

The DAS PC chip includes an input optical coupler formed on or supported by the substrate as an optical input port for the DAS PC chip for coupling the input optical signal from the sensing fiber into the DAS PC chip. This input optical couple may, for example, include a second SSC for matching the mode field diameter of the input fiber pigtail. Associated with this input optical coupler, an input optical waveguide is formed on or supported by the substrate for supporting light in both the TE and TM polarizations, and a polarization splitting rotator (PSR) is formed on or supported by the substrate to split the orthogonal polarization component from the sensing fiber into separate paths and rotating the TM 90 degrees to TE mode, two 1×2 couplers C1 and C2 are formed on the substrate each to split the light in each path into two optical arms formed by on-substrate optical waveguides with an optical delay line in one of the two arms, and two coherent optical receivers each to receive the light from the two arms. The two optical coherent receivers are coupled to communicate with the control electronic circuitry for controlling or operating the DAS PIC chip.

The polarization splitting rotator (PSR) is a polarization device supported by the substrate to receive the backscattered light from the sensing fiber and to split the received backscattered light from the sensing fiber into first optical beam in a first polarization (e.g., the TE mode) and a second optical beam in a second polarization (e.g., the TM mode) that is orthogonal to the first polarization and to rotate the second polarization of the second optical beam by 90 degrees to produce a second polarization beam in the first polarization (the TE mode). The output beams of the PSR are in the TE mode and are guided the waveguides in the TE mode as shown in FIG. 1.

In implementations of the above design for DAS applications, the optical pulses may be designed to have a high extinction ratio (ER) on the order of 50-70 dB for required detection sensitivity, which may not be readily achieved with the optical modulator/switch under certain constructions or designs. Under the design in FIG. 1, the on-chip SOA can be placed between the optical modulator/switch and the chip output port and is driven with a reverse voltage to make the SOA highly absorptive, which can be used as both the amplifier and the high ER optical pulse generator. Accordingly, the on-chip SOA can be heterogeneously integrated inside the chip or hybridly integrated at the edge of the chip before coupling into the output fiber to further improve the extinction ratio ER of the output light from the optical modulator/switch. Similarly, the on-chip laser can be heterogeneously integrated inside the chip or hybridly integrated at the edge of the chip. Furthermore, in some implementations, the modulator/switch can be removed and only SOA is used to accomplish the switching function with a high ER by driving the SOA with a pulsed electrical signal.

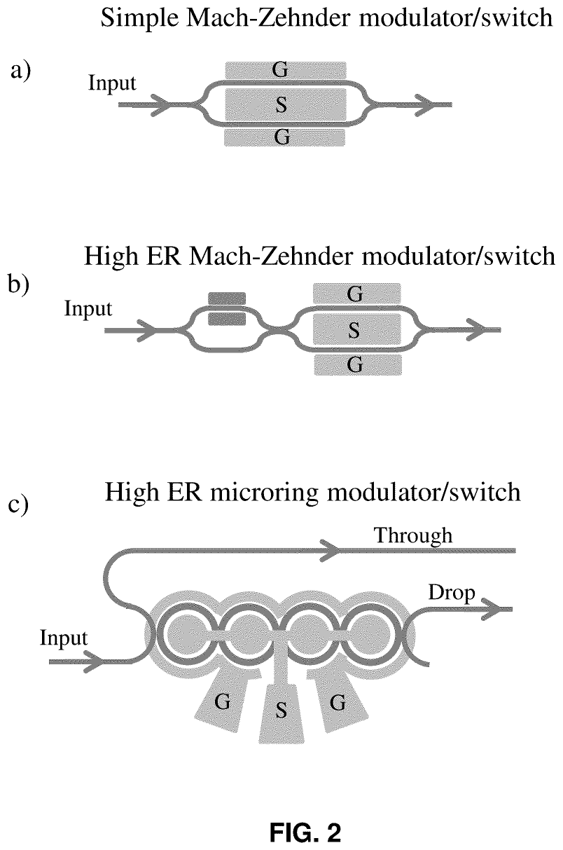

FIG. 2 shows examples of three different examples of configurations of the modulators/switches which can be used in FIG. 1. FIG. 2a is a standard Mach-Zehnder modulator (MZM) configuration with an input optical splitter to split the input into two different optical paths and an output optical combiner to combine the different optical signal sin the two different paths into a common output optical path. This MZM by itself may not be able to achieve sufficiently high ER satisfying the DAS requirement, because the powers in the upper and lower branches of the MZM modulators are difficult to be made exactly the same due to the slight coupling ratio differences of the two couplers and the slight transmission loss difference between the two branches.

FIG. 2b shows an example of one configuration of an improved MZM modulator with two MZM modules. This design includes a Mach-Zehnder interferometer (MZI) placed before an MZM, in which the MZI can be used as a tunable coupler by tuning the relative phase between the two arms of the MZI. A tunable phase shifter which can be tuned (e.g., thermally) by applying an electrical current to the resistive stripe on one of the arms to ensure optimized ER of the MZM.

FIG. 2c is a modulator made with multiple microrings for achieving a high ER.

These configurations can be implemented on thin film lithium niobate (TFLN) or silicon on insulator (SOI) platforms for the DAS PIC chip in FIG. 1 and other chip designs in this application.

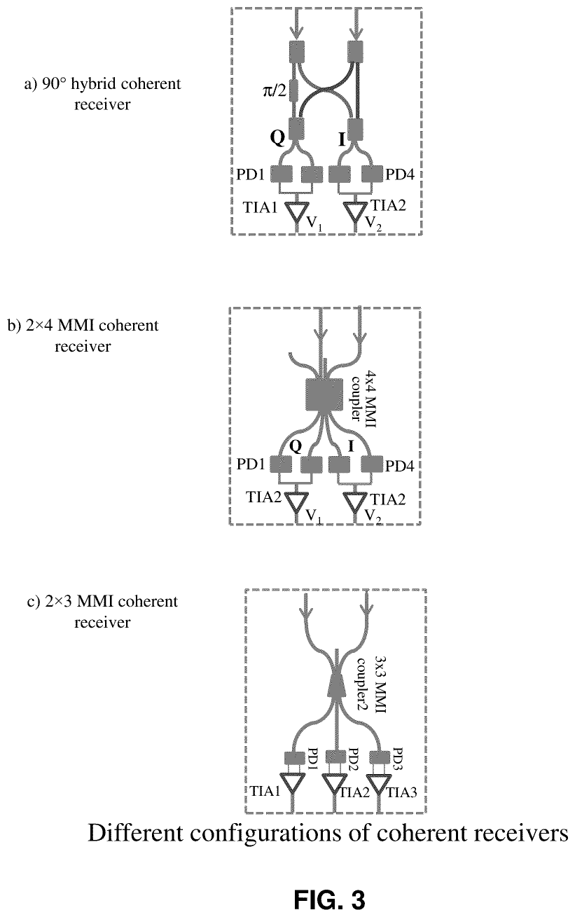

FIG. 3 shows examples of three different configurations of optical coherent receivers for DAS PIC chips, with FIG. 3a showing a 90° hybrid with the outputs from the Q ports and I ports proportional to the sine and cosine of the phase Δφ(t) between the two inputs, respectively:

$${P}_{Q 1} = {A}_{1} + {B}_{1} sin [ Δφ ( t ) ] \qquad ( 1 a )$$

$${P}_{Q 2} = {A}_{2} - {B}_{2} sin [ Δφ ( t ) ] \qquad ( 1 b )$$

$${P}_{I 1} = {A}_{3} + {B}_{3} cos [ Δφ ( t ) ] \qquad ( 1 c )$$

$${P}_{I 2} = {A}_{4} - {B}_{4} cos [ Δφ ( t ) ] \qquad ( 1 d )$$

where Aᵢ and Bᵢ (i=1, 2, 3, 4) are constants.

In various implementations, the hardware design may be used to set the following conditions: Aᵢ=Aⱼ=A, Bᵢ=Bⱼ=B, the phase difference between the two input signals under such conditions can be expressed as:

$$Δφ ( t ) = {tan}^{- 1} [ \frac{{P}_{Q 1} - {P}_{Q 2}}{{P}_{Q 1} + {P}_{Q 2}} \frac{{P}_{I 1} - {P}_{I 2}}{{P}_{I 1} + {P}_{I 2}} ] \vert \qquad ( 1 e )$$

FIG. 3b shows a coherent receiver configured with a 4×4 multimode interference (MMI) coupler, in which two of the four input ports are used to generate a pair of Q ports proportional to the sine function and a pair of I ports proportional to the cosine function of the phase between the two input signals, respectively, as also described by Equations (1a) to (1e) above.

FIG. 3c shows a coherent receiver configured with a 3×3 MMI coupler, where 2 input ports are used for inputting two optical signal to extract their phase difference, while the optical powers from the three output ports can be expressed as:

$${P}_{1} = A + B sin [ Δφ ( t ) ] \qquad ( 2 a )$$

$${P}_{2} = A + B sin [ Δφ ( t ) - 120 ° ] \qquad ( 2 b )$$

$${P}_{3} = A + B sin [ Δφ ( t ) + 120 ° ] \qquad ( 2 c )$$

$$Δφ ( t ) = {tan}^{- 1} [ \frac{2 {P}_{1} - ( {P}_{2} + {P}_{3} )}{\sqrt{3} ( {P}_{2} - {P}_{3} )} ] \qquad ( 2 d )$$

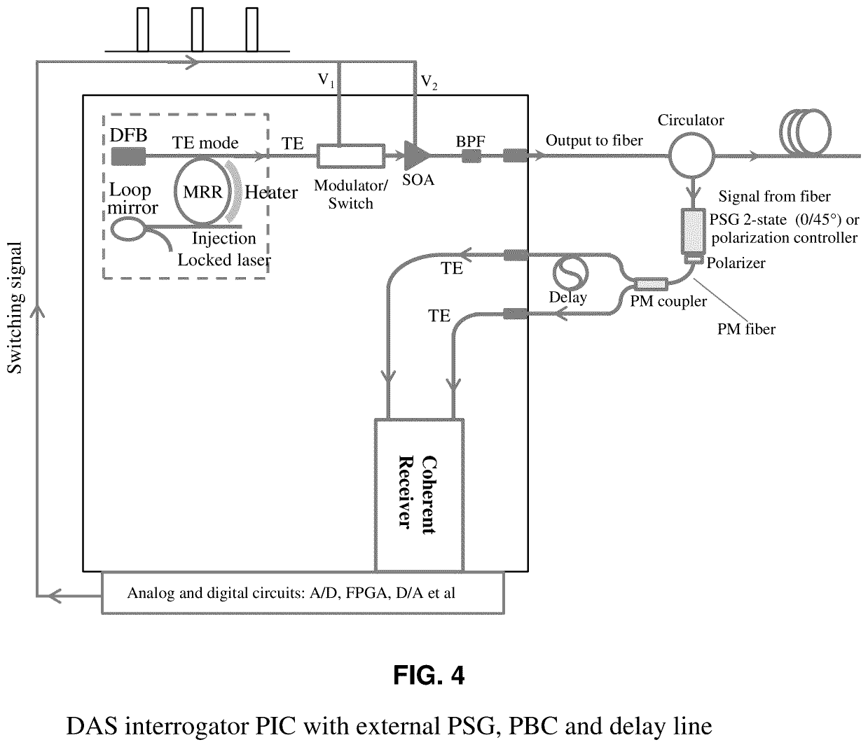

FIG. 4 illustrates an example of a second embodiment of a DAS interrogator chip based on the disclosed technology in this patent document. This chip includes an on-chip laser such as an injection locked DFB laser, an on-chip optical pulse generator (modulator and SOA), an on-chip optional bandpass filter (BPF), three on-chip spot size converters (SSC) for matching the mode field diameter with that of the fiber pigtails, an off-chip circulator for routing the light into and out of the sensing fiber, an off-chip 45° polarization rotator or a polarization controller followed by an off-chip polarizer to reduce polarization sensitivity of the returned signal from the fiber, an off-chip polarization maintaining PM coupler to split the light into two arms, an off-chip delay fiber around 1-20 meters placed in one of the arms, and one on-chip optical coherent receiver to receive light from the two arms and extract the differential phase fluctuations between the two arms, which represents the local phase fluctuations. The pigtails of the PM coupler, including the delay fiber, are all of PM fiber. The modulator/switch is used to generate optical pulses with high extinction ratio using electric pulses generated by the electronic circuit and the SOA is used to amplify the optical signal in sync with the modulator/switch. The modulator/switch can be removed and only SOA is used to accomplish the switching function by driving it with pulsed electrical signal, like the case of FIG. 1. In this design in FIG. 4, two input optical couplers are provided to receive the two input optical signals from the off-chip PM coupler. The single optical coherent receiver in FIG. 4 is coupled to communicate with the control electronic circuitry for controlling or operating the DAS PIC chip.

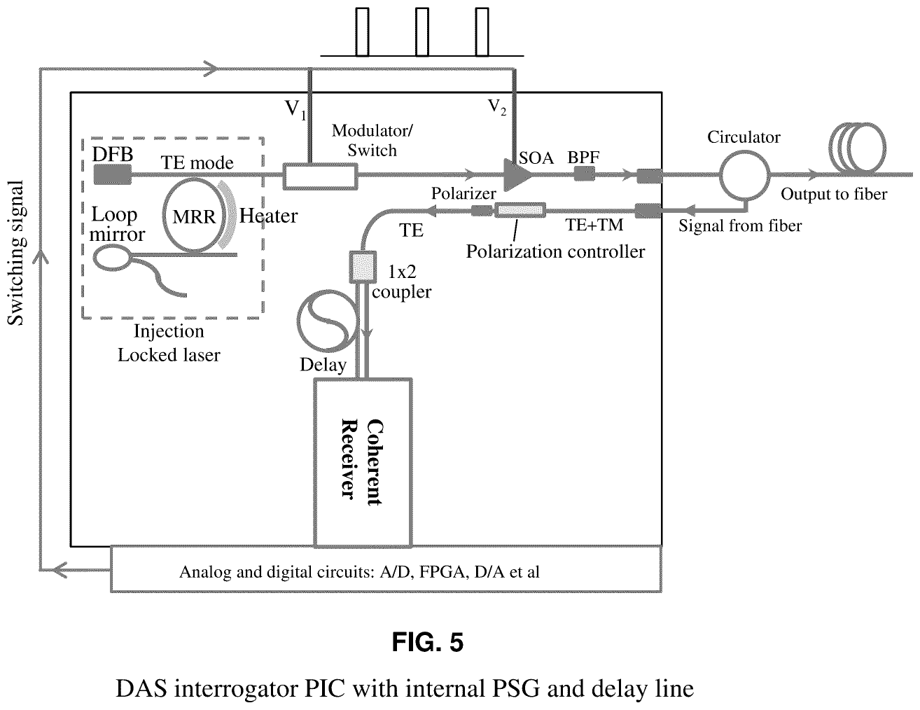

FIG. 5 illustrates an example of a third embodiment of the disclosed DAS interrogator similar to that of FIG. 4, except the polarization controller is placed on the chip, followed by a TE pass polarizer and a 1×2 coupler to split the light into two arms, an optical delay or the order of 0.1 to 10 m is placed in one of the arms, and a coherent receiver to receive light from the two arms to extract the local phase disturbances caused by the acoustics and vibrations. Many types of polarization controllers can be implemented on different PIC platforms, such as those described in [5-7].

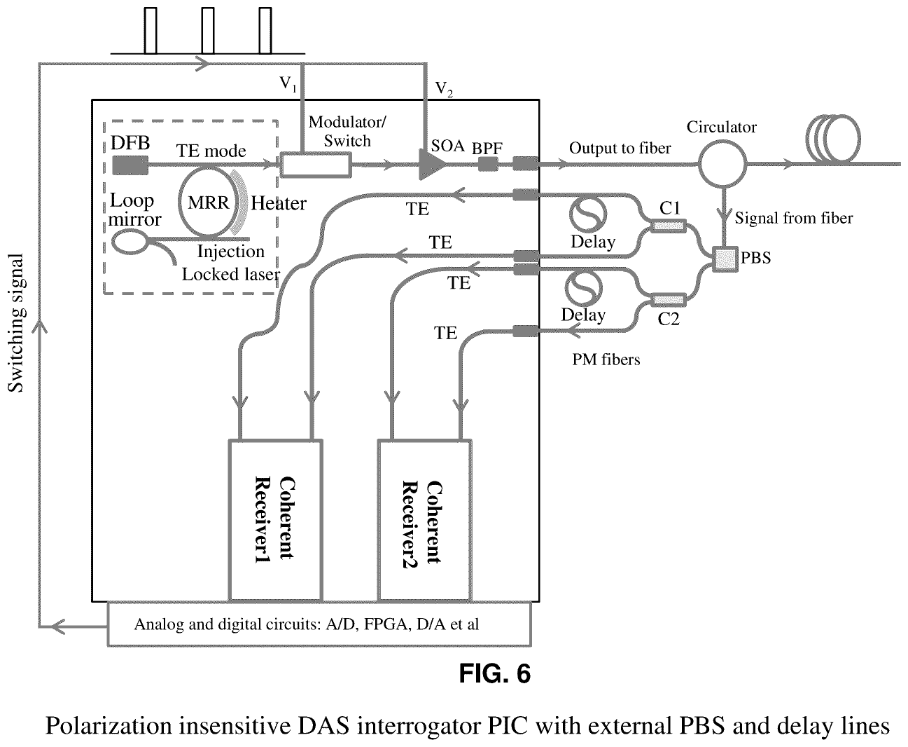

FIG. 6 illustrates an example of a fourth embodiment of the disclosed DAS interrogator similar to that of FIG. 4, except two coherent receivers are used for polarization diversity. In particular, a polarization beam splitter (PBS) outside of the PIC chip is used to split two orthogonal polarizations into two paths, each path is further split into two arms, with the signal in one of the arms being delayed by an extra length of fiber on the order of 0.1 to 10 m, before both arms enter their corresponding coherent receiver to extract vibration information in the sensing fiber. Note that the two output fibers from the PBS are of polarization maintaining (PM) fiber. C1 and C2 are PM fiber couplers and their pigtails, including the delay fiber, are also of PM fiber.

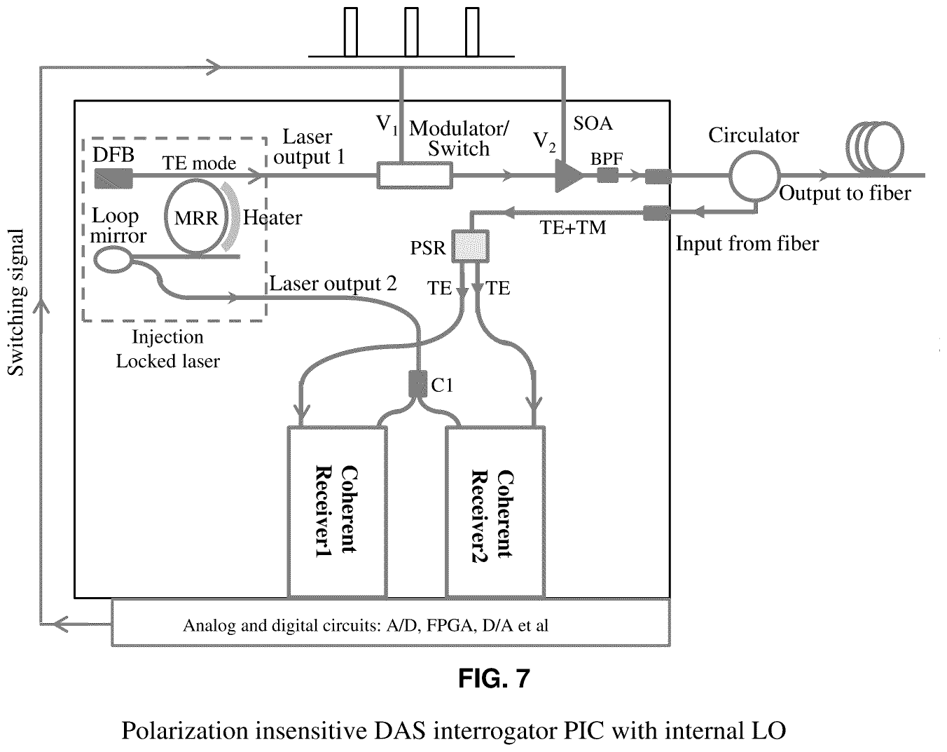

FIG. 7 illustrates an example of a fifth embodiment of the disclosed DAS interrogator to obtaining the sensing signal from the fiber by beating the backscattered/reflected signals with the laser light directly from the laser. Laser light from output 1 is first converted into optical pulse by the modulator/switch and the SOA before output to the sensing fiber. The backscattered and reflected light from the sensing fiber is separated by an optical circulator from the output light before entering the input waveguide with an SSC via a short length of single mode (SM) fiber, which then propagates in a waveguide supporting both TE and TM modes before being split by a PSR with the TE mode going to a first port and the TM mode going to the second port after being rotated 90 degrees to become a TE mode. On the other hand, the light from the laser source is split into two waveguides before mixing with the lights from the two ports of the PSR in two coherent receivers, respectively, to producing two sets of mixed signals containing the local phase information, which can be extracted with further data processing to get local vibration induced phase fluctuations along the fiber.

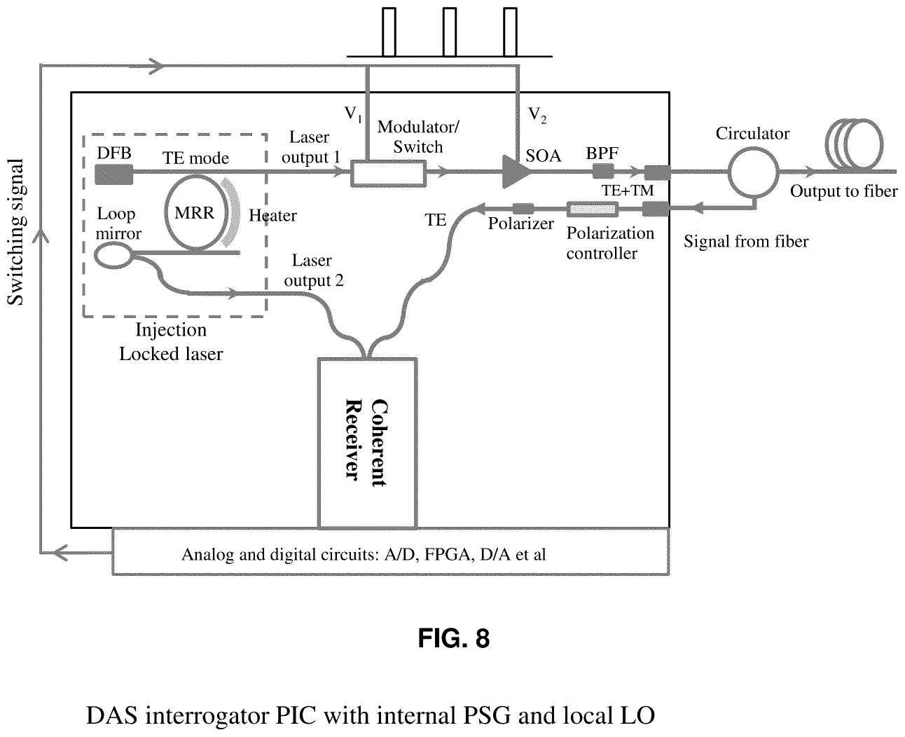

FIG. 8 illustrates an example of a sixth embodiment of the disclosed DAS interrogator for obtaining the sensing signal from the fiber by beating the backscattered/reflected signals with the laser light directly from the laser, similar to that of FIG. 7, but only uses a single coherent receiver. Laser light from output 1 is first converted into optical pulse by the modulator/switch and the SOA before output to the sensing fiber. The backscattered and reflected light from the sensing fiber is separated by an optical circulator from the output light before entering the input waveguide with an SSC via a short length of single mode (SM) fiber, which then propagates in a waveguide supporting both TE and TM modes. The state of polarization (SOP) of the light is then controlled by a polarization controller or rotator, followed by the polarizer before entering the coherent receiver through another piece of waveguide to mix with the light directly from the injection locked DFB laser to produce an interference signal containing the local phase fluctuation information, which can be extracted with further data processing to get local vibration information along the fiber.

While this patent document contains many specifics, these should not be construed as limitations on the scope of any subject matter or of what may be claimed, but rather as descriptions of features that may be specific to particular embodiments of particular techniques. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Only a few implementations and examples are described, and other implementations, enhancements and variations can be made based on what is described and illustrated in this patent document.

I/We claim:

1. An optical sensing device for distributed acoustic sensing using a sensing fiber, comprising:
a substrate;
a laser supported by the substrate to produce laser light;
an optical modulator supported by the substrate and located to receive the laser light from the laser to produce laser pulses for sensing local phase disturbances at various locations along the sensing fiber by detecting backscattering light of the laser pulses at the various locations along the fiber;
a polarization device supported by the substrate to receive the backscattered light from the sensing fiber and to split the received backscattered light from the sensing fiber into first optical beam in a first polarization and a second optical beam in a second polarization that is orthogonal to the first polarization and to rotate the second polarization of the second optical beam by 90 degrees to produce a second polarization beam in the first polarization;
a first optical coupler configured to split the first optical beam into two branches, with one of the branches having a longer path than the other branch;
a second optical coupler configured to split the second optical beam into two branches, with one of the branches having a longer path than the other branch;
a first optical coherent receiver supported by the substrate to receive the two beams from the first optical coupler derived from the first optical beam in the first optical polarization to produce three or more first optical coherent receiver output signals that carry information of local phase disturbances at various locations along the sensing fiber; and
a second optical coherent receiver supported by the substrate to receive the two beams from the second optical coupler derived from the second optical beam in the first optical polarization to produce two or more second optical coherent receiver output signals that carry information of local phase disturbances at various locations along the sensing fiber.

2. The optical sensing device as in claim 1, wherein:
the optical modulator supported by the substrate includes a Mach-Zehnder optical modulator.

3. The optical sensing device as in claim 1, wherein:
the optical modulator supported by the substrate includes a Mach-Zehnder interferometer and a Mach-Zehnder optical modulator in series.

4. The optical sensing device as in claim 1, wherein:
the optical modulator supported by the substrate includes a semiconductor optical amplifier that amplifies the laser light into modulated light of laser pulses.

5. The optical sensing device as in claim 1, wherein:
the optical modulator supported by the substrate includes different optical microring modulators that are optically coupled to one another.

6. The optical sensing device as in claim 1, wherein:
one of the first or second optical coherent receiver includes a 90-degree hybrid coherent receiver.

7. The optical sensing device as in claim 1, wherein:
one of the first or second optical coherent receiver includes a by 4×4 multimode interference (MMI) coupler to receive two input beams and to output a first pair of first and second output beams and a second pair of third and fourth output beams with a 90 degree phase difference between the first and second pair, and four optical detectors to receive and detect the first, second, third and fourth output beams, respectively.

8. The optical sensing device as in claim 1, wherein:
one of the first or second optical coherent receiver includes a by 3×3 multimode interference (MMI) coupler to receive two input beams and to output three output beams, and three optical detectors to receive and detect the three output beams, respectively.

9. The optical sensing device as in claim 1, wherein:
the laser supported by the substrate includes a distributed feedback laser and a microring resonator that is optically coupled to the distributed feedback laser to effectuate an injection locking of a frequency of the laser light.

10. The optical sensing device as in claim 1, further comprising:
an electronic circuit to generate electrical pulses to drive the optical modulator and to receive respective detected signals from the first and second coherent receivers at different times with respect to the electrical pulses to determine the phases and distances of reflected light from various locations along the sensing fiber.

11. An optical sensing device for distributed acoustic sensing using a sensing fiber, comprising:
a substrate;
a laser supported by the substrate to produce laser light;
an optical modulator supported by the substrate and located to receive the laser light from the laser to produce laser pulses for sensing local phase disturbances at various locations along the sensing fiber by detecting backscattering light of the laser pulses reflected at the various locations along the fiber;
a 2-state polarization generator (PSG) or a polarization controller with an output polarizer coupled to receive the backscattered light from the sensing fiber and to control optical polarization of the received backscattered light from the sensing fiber;
an optical coupler configured to split light from the 2-state polarization generator (PSG) or the polarization controller into first optical beam and a second optical beam in a common polarization traveling in waveguides of different lengths;
an optical coherent receiver supported by the substrate to receive the first optical and the second optical beam to produce different optical coherent receiver output signals that carry information of local phase disturbances at various locations along the sensing fiber.

12. The optical sensing device as in claim 11, wherein:
the 2-state polarization generator (PSG) or the polarization controller with the output polarizer, and the optical coupler are outside the substrate.

13. The optical sensing device as in claim 11, wherein:
the 2-state polarization generator (PSG) or the polarization controller with the output polarizer, and the optical coupler are supported by the substrate.

14. An optical sensing device for distributed acoustic sensing using a sensing fiber, comprising:
a substrate;
a laser supported by the substrate to produce laser light;
an optical modulator supported by the substrate and located to receive the laser light from the laser to produce laser pulses for sensing local phase disturbances at various locations along the sensing fiber by detecting backscattering light of the laser pulses reflected at the various locations along the sensing fiber;
a polarization device outside the substrate to receive the backscattered light from the sensing fiber and to split the received backscattered light from the sensing fiber into first optical beam in a first polarization and a second optical beam in a second polarization that is orthogonal to the first polarization;
a first optical coupler to receive the first optical beam in the first polarization and to split the first optical beam into two first optical beams in the first polarization;
a second optical coupler to receive the second optical beam in the second polarization and to split the second optical beam into two second optical beams in the second polarization;
a first optical coherent receiver supported by the substrate to receive the two first optical beams in the first optical polarization to produce two or more first optical coherent receiver output signals that carry information of local phase disturbances at various locations along the sensing fiber; and
a second optical coherent receiver supported by the substrate to receive the two second optical beams in the first optical polarization to produce two or more second optical coherent receiver output signals that carry information of local phase disturbances at various locations along the sensing fiber.

15. The optical sensing device as in claim 14, wherein:
The 2 first optical beams have a relative delay by causing one of the 2 first optical beams to travel in a longer waveguide than the other one of the 2 first optical beams.

16. An optical sensing device for distributed acoustic sensing using a sensing fiber, comprising:
a substrate;
a laser supported by the substrate to produce laser light;
an optical modulator supported by the substrate and located to receive the laser light from the laser to produce laser pulses for sensing local phase disturbances at various locations along the sensing fiber by detecting backscattering light of the laser pulses reflected at the various locations along the sensing fiber;
a polarization device supported by the substrate to receive the backscattered light from the sensing fiber and to split the received backscattered light from the sensing fiber into first optical beam in a first polarization and a second optical beam in a second polarization that is orthogonal to the first polarization and to rotate the second polarization of the second optical beam by 90 degrees to produce a second polarization beam in the first polarization;
a first optical coherent receiver supported by the substrate to receive (1) the first optical beam in the first optical polarization and (2) a first portion of the laser light from the laser as a first local optical oscillator signal for optical coherent detection to produce two or more first optical coherent receiver output signals that carry information of local phase disturbances at various locations along the sensing fiber; and
a second optical coherent receiver supported by the substrate to receive (1) the second optical beam in the second optical polarization and (2) a second portion of the laser light from the laser as a second local optical oscillator signal for optical coherent detection to produce two or more second optical coherent receiver output signals that carry information of local phase disturbances at various locations along the sensing fiber.

17. The optical sensing device as in claim 16, wherein:
the optical modulator includes a Mach-Zehnder optical modulator.

18. The optical sensing device as in claim 16, wherein:
the optical modulator includes a Mach-Zehnder interferometer and a Mach-Zehnder optical modulator in series.

19. The optical sensing device as in claim 16, wherein:
the optical modulator includes different optical microring modulators that are optically coupled to one another.

20. An optical sensing device for distributed acoustic sensing using a sensing fiber, comprising:
a substrate;
a laser supported by the substrate to produce laser light;
an optical modulator supported by the substrate and located to receive the laser light from the laser to produce laser pulses for sensing local phase disturbances at various locations along the sensing fiber by detecting backscattering light of the laser pulses reflected at the various locations along the sensing fiber;
a polarization controller supported by the substrate and coupled to receive the backscattered light from the sensing fiber and to control optical polarization of the received backscattered light from the sensing fiber;
a polarizer supported by the substrate to select a portion of output light from the polarization controller as a polarized output light; and
an optical coherent receiver supported by the substrate to receive (1) the polarized light and (2) a portion of the laser light from the laser as a local optical oscillator signal for optical coherent detection to produce different optical coherent receiver output signals that carry information of local phase disturbances at various locations along the sensing fiber.

21. The optical sensing device as in claim 20, wherein:
the optical modulator includes a Mach-Zehnder optical modulator.

22. The optical sensing device as in claim 20, wherein:
the optical modulator includes a Mach-Zehnder interferometer and a Mach-Zehnder optical modulator in series.

23. The optical sensing device as in claim 20, wherein:
the optical modulator includes different optical microring modulators that are optically coupled to one another.
